(19) United States
(12) Patent Application Publication
(10) Pub. No.: US 2026/0024005 A1
(43) Pub. Date: Jan. 22, 2026

(54) DCF-ENHANCED EDGE-ASSISTED MACHINE LEARNING

(71) Applicant: Dell Products L.P., Round Rock, TX (US)

(72) Inventors: Pankaj PANDE, Carlingford (AU); Stephen J. Todd, North Andover, MA (US)

(21) Appl. No.: 18/776,032

(22) Filed: Jul. 17, 2024

(51) Int. Cl. G06N 20/00

(52) U.S. Cl. CPC G06N 20/00

(57) ABSTRACT

A computing system may identify data provided by a plurality of edge nodes that is to be used in training or updating a machine learning (ML) model. The computing system may identify a confidence score associated with the data provided by a plurality of edge nodes. The computing system may place the data provided by the plurality of edge nodes that is determined to have a high confidence score into a first queue. The computing system may place the data provided by the plurality of edge nodes that is determined to have a low confidence score into a second queue. The computing system may use the data placed into the first queue and/or the second queue to train or update the ML model.

### TECHNOLOGICAL FIELD OF THE DISCLOSURE

Embodiments disclosed herein generally relate to generally relate to data confidence fabric networks and data delivery in data confidence fabric networks. More particularly, at least some embodiments relate to systems, hardware, software, computer-readable media, and methods for using higher confidence data to train or update a machine learning model.

### BACKGROUND

Computing and other electronic devices come in a variety of types and form factors and have varying capabilities. Many of these devices generate data that may be used by various applications. There is often a question, however, about the value of the data or the confidence that an application can place in the data. In other words, applications benefit from using data in which there is high confidence. Applications that execute using data associated with high confidence levels typically generate more reliable results and outputs.

Applying trust services or functions to data allows applications or users to trust the data and can improve the confidence in how the data is used and in the results of using the data. Providing trust services or functions, however, is not without cost.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a computing system such as a data confidence fabric network;

FIG. 2 discloses additional aspects of a computing system such as a data confidence fabric network;

FIG. 3 discloses aspects of training or updating a machine learning model in a computing system such as a data confidence fabric network;

FIG. 4 discloses aspects of a method according to one embodiment; and

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to generally relate to data confidence fabric networks and data delivery in data confidence fabric networks. More particularly, at least some embodiments relate to systems, hardware, software, computer-readable media, and methods for using higher confidence data to train or update a machine learning model.

In one example embodiment, a computing system may identify data provided by a plurality of edge nodes that is to be used in training or updating a machine learning (ML) model. The computing system may identify a confidence score associated with the data provided by a plurality of edge nodes. The computing system may place the data provided by the plurality of edge nodes that is determined to have a high confidence score into a first queue. The computing system may place the data provided by the plurality of edge nodes that is determined to have a low confidence score into a second queue. The computing system may use the data placed into the first queue and/or the second queue to train or update the ML model.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may provide data for training or updating a machine learning (ML) model based on data confidence levels, thus ensuring that higher confidence data is used when training or updating the ML model. In an embodiment, a confidence threshold is configurable to ensure the proper amount of higher confidence data is used in training or updating the ML model. Various other advantages of one or more example embodiments will be apparent from this disclosure.

### A. ASPECTS OF AN EXAMPLE DATA CONFIDENCE FABRIC (DCF)

Embodiments of the present invention generally relate to computing systems or ecosystems such as data confidence fabrics (DCFs). In one example, a DCF is a system or network of hardware (e.g., computers, servers, routers, network interface cards, storage including immutable storage and/or other hardware) that is provisioned (e.g., with software, services) to score or rank data that may be ingested into and/or transmitted through the DCF. Communications in a DCF may include wired (e.g., ethernet) and/or wireless communications. The data ingested into the DCF can be made available to applications, which may also be part of the DCF. The applications can leverage the confidence scores of the data.

In some example embodiments, applications or other data sources may generate and/or share data with other applications or users. Trust in this data can be improved by joining a DCF that is configured to perform trust functions to or on the data. These trust functions (e.g., trust insertion technologies) may be provided by various providers and may be hardware based and/or software based.

A DCF may include an interface system. Applications may access the interface system using, for example, an API (Application Programming Interface). The interface system may be configured to provide publishing functionality and payment as a service functionality such that trust providers can charge a fee for use of their trust functions or trust insertion technologies. In one example, a smart contract may be used to facilitate these publishing and payment operations. In one example, payment may be collected when annotations, which reflect trust functions that have been applied to the data, are written to a distributed ledger. Thus, the payment as a service provided by the DCF is coupled with or relates to the act or step of publishing annotations to a distributed ledger. In another example, the act or step of providing payment as a service may be decoupled from the act or step of publishing trust information.

A DCF is generally configured to add or associate annotations to data. The annotations include confidence information, which can take various forms including a confidence score, trust information, and/or associated metadata. The confidence information can be added from a hardware perspective and/or a software perspective.

A DCF, by way of example only, may be an architecture and set of services that allow data to be ingested and used by applications. The DCF may include or be associated with trust insertion technologies (hardware and/or software) that are applied to the data as the data flows through the DCF. Each time a trust insertion technology is applied, an annotation may be made in a ledger or other structure and the confidence score of the data may be changed. Thus, the confidence score of data provides a view into the trustworthiness of the data to an application. Trust or confidence information can be added from both hardware and software perspectives. Data may be associated with an overall confidence score. In addition, a confidence score may be generated for each trust insertion technology. This allows an application, for example, to evaluate how to trust the data in the context of a specific trust insertion technology.

The trust insertion technologies may be applied by performing trust functions. Further, each of the trust insertion technologies may be associated with a trust provider.

A DCF may include various interconnected hardware environments (e.g., nodes). These nodes may have varying hardware capabilities that are examples of trust insertion technologies or hardware-assisted trust insertion technologies. The hardware is configured, such that as data flows from data sources to storage or to applications in a DCF system, scores or confidence information or other annotations can be attached to or associated with the data. As the data is handled by various forms of trust insertion technologies, the overall score or ranking (e.g., a confidence or trustworthiness score) of the data may change. The data scored or ranked in the DCF system may be stored in various locations, such as a data lake, in a datacenter, Public Cloud data storage service, or the like. The annotations, which may include confidence information, a confidence score and/or rank, is made available to one or more applications or other clients or users. The confidence information may include, in addition to a confidence score and/or rank, tables, audit information, and the like.

Confidence scores, which may be determined from hardware aspects and/or software aspects of a DCF, allow an application to explore or exploit the data for potential analysis or consumption. The confidence score or rank of the data allows an application to understand or account for the trustworthiness of the data. For example, the confidence score of the data may have an impact on whether the data is actually used by the application. An application may require a minimum confidence score or have other requirements related to the confidence score.

For example, an application operating in a nuclear facility may need to use data that are very trustworthy (have a high confidence score) while data that is used by an application to control lights in a home may not need to be as trustworthy (a lower confidence score is acceptable). In the context of a nuclear facility, an application may require that the hardware handling the data be firewalled from outside sources, provide hardware assisted encryption, deterministic routing, or the like or combination thereof while data used to control lights may not require these trust services. The trust functions required or desired by an application can be specified and the DCF may perform these trust functions when available. The payment as a service allows payment to be made for each trust function that is performed, each time annotations are committed to a distributed ledger, or the like.

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

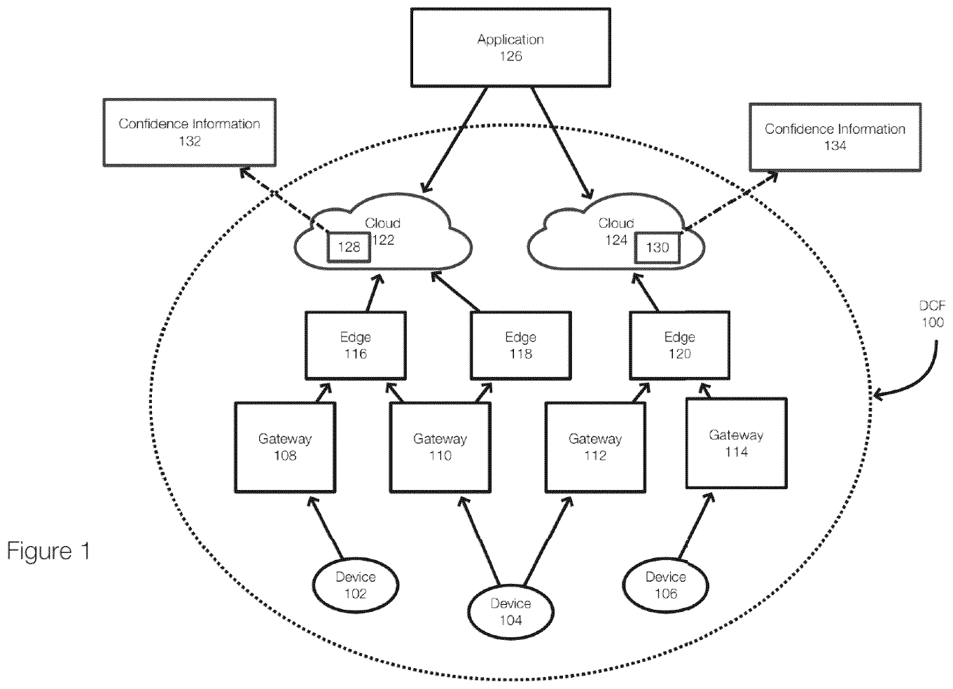

FIG. 1 illustrates an example of a data confidence fabric network (DCF 100). The DCF 100 includes varies computing and hardware components, connections, and environments. The DCF 100 is configured to add confidence information including confidence scores to data flowing in the DCF 100.

FIG. 1 illustrates examples of data routes or paths in the DCF 100. A specific path of specific data may be referred to as a graph. In FIG. 1, data generated by devices 102, 104, and 106 may flow through multiple levels or multiple hardware environments such as gateways 108, 110, 112, and 114, edge nodes 116, 118, 120, and clouds 122 and 124. In one example, the data may be stored in the clouds 122 and 124.

As the data 128 and the data 130 flow through the DCF 100, the DCF 100 may add annotations (e.g., confidence information) to the data. After flowing through the DCF 100, the data 128 (which may have been generated by one of the devices 102, 104, and/or 106) is stored in the cloud 122 and made available to an application 126. Similarly, the data 130 may be made available to the application 126. Alternatively, the data 128 and 130 are delivered directly to the application 126. The data 128 is associated with confidence information 132 and the data 130 is associated with confidence information 134. The confidence information 132 and 134 may include confidence scores, provenance data, audit trails, data graphs, applied trust insertion technologies or trust functions, or the like. Data flowing through a DCF is typically more valuable and useful at least because the confidence scores or ranks of DCF annotated data allow an application to decide how to trust and/or use the associated data.

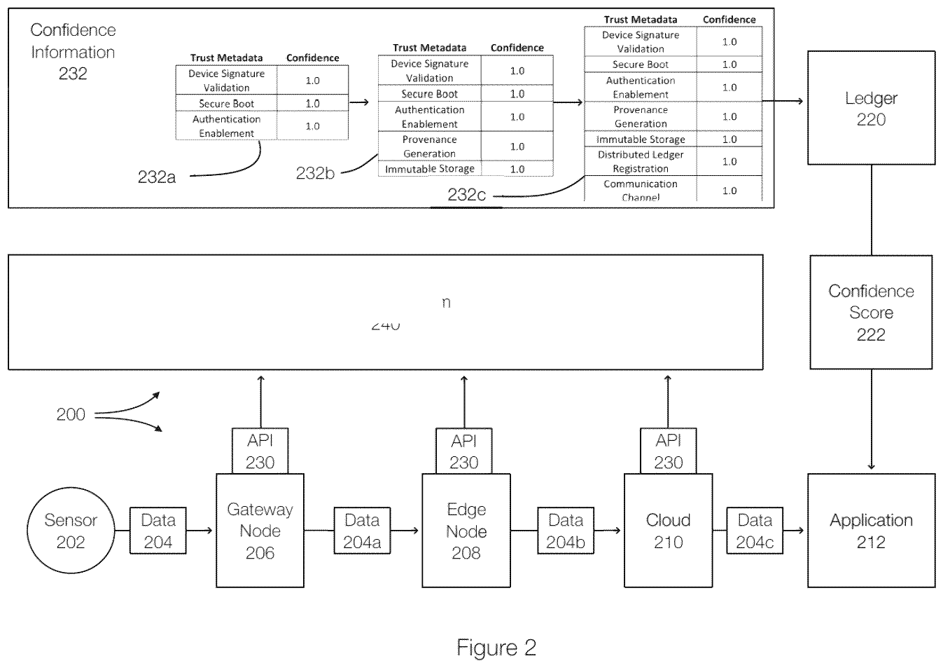

FIG. 2 discloses additional aspects of a data confidence fabric network. FIG. 2 illustrates a DCF 200, which is an example of the DCF 100. In the DCF 200, data 204 is generated by a sensor 202 (or other devices such as user devices) and is ingested into the DCF 200. The data 204 may be received at a gateway node 206, which interfaces with an interface system 240 of the DCF 200 to annotate the data 204 with confidence information.

As illustrated in FIG. 2, confidence information 232 (also referred to as “trust metadata”) is generated and accompanies the data 204 as the data 204 is routed in the DCF 200. At the gateway node 206, which may have an embedded Intel TPM chip and the gateway node may use that chip to perform “trust services” on behalf of the owner of the data 204, the data 204 is annotated with confidence information 232a, which relates to trust insertion technologies such as a device signature validation, a secure boot, and an authentication enablement. For example, a “secure boot” annotation, in the confidence information 232a for the gateway node 206, may indicate that the gateway node 206 has not been tampered with. The TPM chip may also provide keys used to perform signature services on the data 204. Each of these trust insertion technologies, in this example, are performed and add a score that is reflected in the confidence information 232a. More specifically, the gateway node 206 may access an interface system 240, which may be a DCF SDK (software development kit), using an application programming interface (API) 230, which is an example of a DCF driver, to record the confidence information 232a. The data 204 and the annotations or confidence information may be transmitted together or maintained separately.

Next, the data 204a (which is the annotated data 204 after passing through the gateway node 206) is routed to an edge node 208 and additional confidence information is added as reflected in the confidence information 232b. Thus, the data 204a arrives at the edge node 208 and is already associated with the confidence information 232a. The edge node 208 may add apply additional trust insertion technologies such as provenance generation and immutable storage. These trust insertion technologies allow the confidence information to be augmented as illustrated by the confidence information 232b. Thus, the data 204b leaving the edge node 208 is associated with the confidence information 232b. In one embodiment, in the example of FIG. 2, the edge node 208 may leverage an ARM secure enclave to perform a “trust service,” inspecting the data 204a and performing analytics on it

Next, the data 204b arrives at the cloud 210 and additional confidence information is added as illustrated by the confidence information 232c. Thus, the cloud 210 may apply or use a trust insertion technology such as distributed ledger registration and the confidence information 232 is updated as shown by the confidence information 232c.

In one example, the confidence information 232 is stored in a ledger 220. As a result, the confidence information 232 is secure and can be accessed by an application 212. In this example, the data 204 arrives at the application 212 as the annotated data 204c, which is associated with the annotations or confidence information 232c and with a confidence score of, in this example, 7.0. In this example, the confidence information 232c includes confidence information related to the communication channel and the associated score of 1.0 may reflect that the selection, performance, and operation of a selected communication channel was as expected and used to deliver the data 204c. The application 212 thus has insight into the trustworthiness of the data 204 generated at the sensor 202 and has insight into the communication channel.

The confidence score can be generated in different ways. The various trust insertion technologies may be weighted or have different scores. For example, the DCF 200 may be associated with a maximum confidence score (e.g., 10). If the data 204 had followed a different route in the DCF 200, the confidence score may be different. For example, other nodes may have trust insertion technologies that could have increased the confidence score of the data 204. Different routes may also result in lower confidence scores.

### C. DCF-ENHANCED EDGE ASSISTED MACHINE LEARNING (ML) SYSTEM

### C.1 Discussion of Aspects of an Example Embodiment

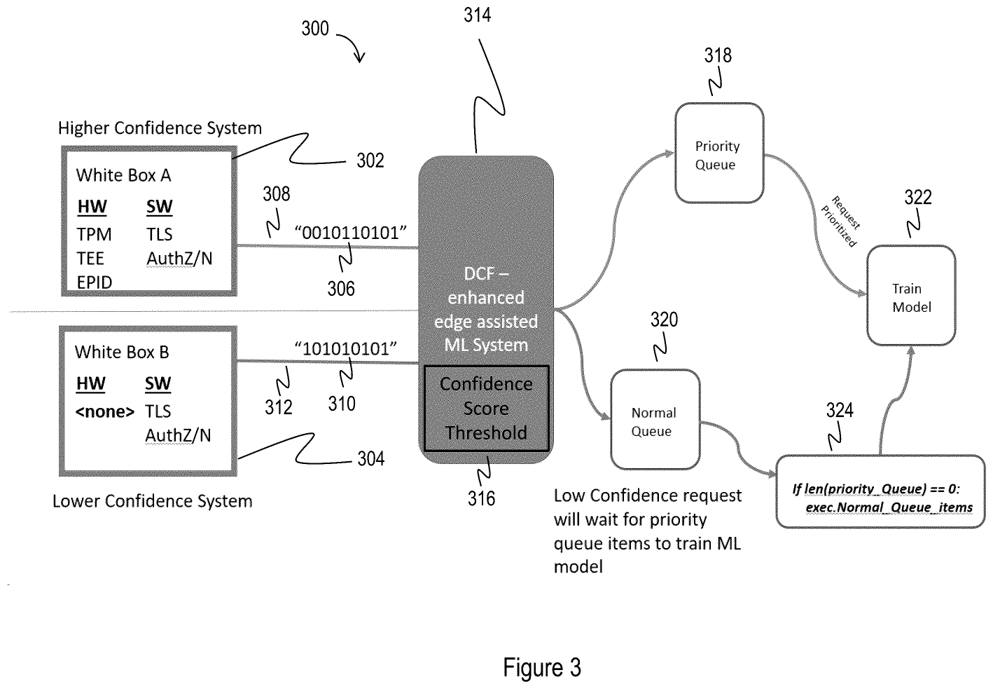

With attention now to FIG. 3, an example architecture 300 according to one embodiment is disclosed. As shown, the architecture 300 may comprise a group of edge devices, such as the edge devices 302 and 304 for example, that are configured to communicate with each other. Each of the edge devices 302 and 304 may comprise a respective node of a DCF, such as DCF 100 or 200, such that data may be passed between the edge devices 302 and 304, and respective confidence scores assigned to the data generated and/or collected by each of the edge devices 302 and 304. In an embodiment, each of the edge devices 302 and 304 assigns respective confidence scores to data that passes through it or is otherwise handled by it, that is, passes through or is otherwise handled by the edge device 302 or 304.

In the illustrative example of FIG. 3, the edge device 302 comprises various hardware security measures such as a Trusted Execution Environment (TEE) and a Trusted Platform Module (TPM). By comparison, the edge device 304 does not include any hardware security measures. As such, a confidence score 306 assigned to data 308 coming from the edge device 302 will be higher than a confidence score 310 assigned to data 312 coming from the edge device 304.

In embodiments, machine learning (ML) models associated with the DCF of the architecture 300, such as a ML model 322, depend on high quality data to optimize their accuracy and effectiveness. However, existing edge-assisted ML learning solutions do not account for varying confidence levels when training and updating ML models, which can affect model performance. Advantageously, the embodiments disclosed herein provide for a DCF-enhanced edge-assisted machine learning (ML) system 314 that helps ensure that data having a high confidence score, and thus is high quality data, is used to train and update the ML models.

Accordingly, in an embodiment, the data 308 and 312, and associated confidence scores 306 and 310, and possibly edge-device unique identifiers, are provided by the edge devices 302 and 304 to the DCF-enhanced edge-assisted ML system 314. The DCF-enhanced edge-assisted ML system 314 uses the confidence scores 306 and 310 to determine if data 308 and 312 is high confidence data or low confidence data. In the embodiment, data having a relatively high confident score would be considered higher confidence data and data having a relatively low confidence level would be considered lower confidence data. For example, suppose in the embodiment that the confidence scores 306 and 310 were assigned on a scale of 1 to 10. In such embodiment, a score of 7 or higher could be considered a high confidence score. Thus, if the confidence score 306 was 7 or higher, then the data 308 would be considered higher confidence data.

In some embodiments, the DCF-enhanced edge-assisted ML system 314 includes a configurable confidence score threshold 316. The configurable confidence score threshold 316 allows a user to set a specific confidence score that will be considered as a high confidence score. For example, suppose in the embodiment that the confidence scores 306 and 310 were assigned on a scale of 1 to 10. In such case, a user who desired very high confidence data when training or updating the ML model 322 might set the configurable confidence score threshold 316 at 9, thus ensuring that only data having a confidence score of 9 or higher would be considered high confidence data. In contrast, a user who wanted a larger amount of data to be used when training or updating the ML model 322 might set the configurable confidence score threshold 316 at 5, thus ensuring that data having a confidence score of 5 or higher would be considered high confidence data.

The received high confidence data is then placed by the DCF-enhanced edge-assisted ML system 314 in a priority queue 318 to be used in training or updating the ML model 322. The low confidence data, on the other hand, is placed by the DCF-enhanced edge-assisted ML system 314 in a normal queue 320 and may be used in the training or updating of the ML model 322.

In one embodiment, the confidence score 306 is determined to be a high confidence score, thus indicating that the data 308 is higher confidence data. In contrast, the confidence score 310 is considered to be a low confidence score, thus indicating that data 312 is lower confidence data. Accordingly, the higher confidence data 308 is placed in the priority queue 318 and the lower confidence data 312 is placed in the normal queue 320. The higher confidence data 308 in the priority queue 318 is then used to train or update the ML model 322. It will be appreciated that the ML model 322 can be any reasonable ML model and so any reasonable training or updating method can be used in conjunction with the higher confidence data 308 to train or update the ML model 322.

In embodiment, once the higher confidence data 308 (and any other higher confidence data in the priority queue 318) has been used to train or update the ML model 322, the lower confidence data 312 (and any other lower confidence data in the normal queue) is then used to train or update the ML model 322. In other words, the lower confidence data in the normal queue 320 is only used to train or update the ML model 322 after all the higher confidence data in the priority queue 318 is used to train or update the ML model 322 as shown at 324. In this way, the DCF-enhanced edge-assisted ML system 314 ensures that the higher confidence data is given priority in training or updating the ML model 322 and the lower confidence data is only used as needed.

In some embodiments, a user may only want to use the lower confidence data in the normal queue 320 to train or update the ML model 322 if the higher confidence data in the priority queue 318 is not sufficient by itself to train or update the ML model 322. That is, if the higher confidence data in the priority queue 318 provides a large enough training data set, then only the higher confidence data will be used to ensure that the training data set is high quality data. Accordingly, in such embodiments, the higher confidence data in the priority queue 318 is used to train or update the ML model 322. After the higher confidence data is used, the ML model 322 is tested to determine if it is sufficiently trained or updated. If the ML model 322 is sufficiently trained or updated, then there is no need to use the lower confidence data in the normal queue 320. However, if the ML model 322 is not sufficiently trained or updated, then the lower confidence data in the normal queue 320 is also used to train or update the ML model 322.

In some embodiments, none of the data received by the DCF-enhanced edge-assisted ML system 314 may be considered as higher confidence data. That is, none of the received data includes a high confidence score. Accordingly, no data is placed in the priority queue 318. Rather, all the data is placed in the normal queue. As shown at 324, once it is determined that no data is the priority queue 318, the lower confidence data 312 in the normal queue is used to train or update the ML model 322. In some embodiments, however, the user may only desire to use higher priority data to train or update the ML model 322. In such embodiments, the ML model 322 is not trained or updated until such time higher priority data is received and placed in the priority queue 318.

### C.2 Use Case

To briefly illustrate some aspects of one embodiment, consider the following use case. An autonomous vehicle system with multiple edge devices deploying localized machine learning models for real-time decision-making. The DCF-enhanced edge-assisted machine learning system trains and updates models with high-confidence data, resulting in improved accuracy and reliability of real-time decisions.

### D. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

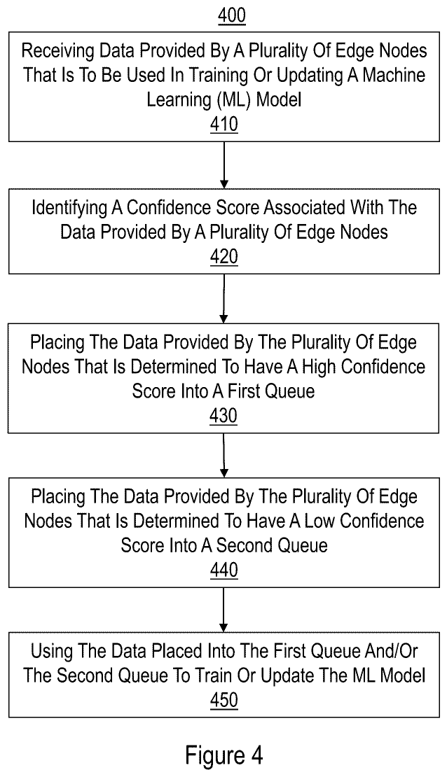

Directing attention now to FIG. 4, an example method 400 is disclosed. The method 400 will be described in relation to one or more of the figures previously described, although the method 400 is not limited to any particular embodiment.

The method 400 includes receiving data provided by a plurality of edge nodes that is to be used in training or updating a machine learning (ML) model (410). For example, as previously described the DCF-enhanced edge-assisted ML system 314 receives the data 308 and 312 from the edge devices 302 and 304. The data 308 and 312 is to be used in training or updating the ML model 322.

The method 400 includes identifying a confidence score associated with the data provided by a plurality of edge nodes (420). For example, as previously described the DCF-enhanced edge-assisted ML system 314 identifies the confidence score 306 that is associated with the data 308 and the confidence score 310 that is associated with the data 312.

The method 400 includes placing the data provided by the plurality of edge nodes that is determined to have a high confidence score into a first queue (430). For example, as previously described the DCF-enhanced edge-assisted ML system 314 determines that the confidence score 306 is a high confidence score, therefore indicating that the data 308 is higher confidence data. The higher confidence data 308 is placed in the priority queue 318.

The method 400 includes placing the data provided by the plurality of edge nodes that is determined to have a low confidence score into a second queue (440). For example, as previously described the DCF-enhanced edge-assisted ML system 314 determines that the confidence score 310 is a low confidence score, therefore indicating that the data 312 is lower confidence data. The lower confidence data 312 is placed in the normal queue 320.

The method 400 includes using the data placed into the first queue and/or the second queue to train or update the ML model (450). For example, as previously described the higher confidence data 308 in the priority queue is used to train or update the ML model 322. In some embodiments, the lower confidence data 312 in the normal queue 320 is also used to train or update the ML model 322.

### E. FURTHER EXAMPLE EMBODIMENTS

Following are some further example embodiments. These are presented only by way of example and are not intended to limit the scope of this disclosure or the claims in any way.
Embodiment 1. A method, comprising: receiving data provided by a plurality of edge nodes that is to be used in training or updating a machine learning (ML) model; identifying a confidence score associated with the data provided by a plurality of edge nodes; placing the data provided by the plurality of edge nodes that is determined to have a high confidence score into a first queue; placing the data provided by the plurality of edge nodes that is determined to have a low confidence score into a second queue; and using the data placed into the first queue and/or the second queue to train or update the ML model.
Embodiment 2. The method as recited in embodiment 1, wherein the plurality of edge nodes comprise respective nodes of a data confidence fabric (DCF).
Embodiment 3. The method as recited in embodiments 1-2, wherein the confidence score concerns performance of hardware and/or software of each of the plurality of edge nodes.
Embodiment 4. The method as recited in any of embodiments 1-3, wherein a confidence score is determined to be a high confidence score, or a low confidence score based on a configurable confidence score threshold.
Embodiment 5. The method as recited in any of embodiments 1-4, further comprising: using the data placed into the second queue to train or update the ML model only after the data in the first queue has been used to train or update the ML model.
Embodiment 6. The method as recited in any of embodiments 1-5, further comprising: after using the data in the first queue to train or update the ML model, determining if the ML model is sufficiently trained or updated; and if the ML model is not sufficiently trained or updated, using the data placed into the second queue to train or update the ML model.
Embodiment 7. The method as recited in any of embodiments 1-6, further comprising: determining that the first queue does not include any data; and in response, using the data placed into the second queue to train or update the ML model.
Embodiment 8. The method as recited in any of embodiments 1-7, wherein only the data placed into the first queue is used to train or update the ML model.
Embodiment 9. A system, comprising hardware and/or software, operable to perform any of the operations, methods, or processes, or any portion of any of these, disclosed herein.
Embodiment 10. A non-transitory storage medium having stored therein instructions that are executable by one or more hardware processors to perform operations comprising the operations of any one or more of embodiments 1-8.

### E. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

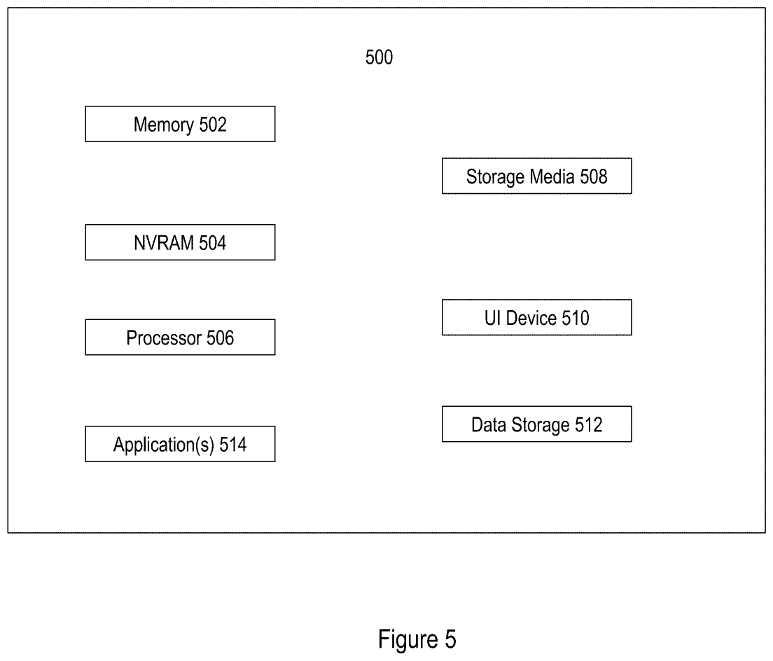

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving data provided by a plurality of edge nodes that is to be used in training or updating a machine learning (ML) model;
identifying a confidence score associated with the data provided by the plurality of edge nodes;
placing the data provided by the plurality of edge nodes that is determined to have a high confidence score into a first queue;
placing the data provided by the plurality of edge nodes that is determined to have a low confidence score into a second queue; and
using the data placed into the first queue and/or the second queue to train or update the ML model.

2. The method of claim 1, wherein the plurality of edge nodes comprise respective nodes of a data confidence fabric (DCF).

3. The method of claim 1, wherein the confidence score concerns performance of hardware and/or software of each of the plurality of edge nodes.

4. The method of claim 1, wherein a confidence score is determined to be a high confidence score, or a low confidence score based on a configurable confidence score threshold.

5. The method of claim 1, further comprising:
using the data placed into the second queue to train or update the ML model only after the data in the first queue has been used to train or update the ML model.

6. The method of claim 1, further comprising:
after using the data in the first queue to train or update the ML model, determining if the ML model is sufficiently trained or updated; and
if the ML model is not sufficiently trained or updated, using the data placed into the second queue to train or update the ML model.

7. The method of claim 1, further comprising:
determining that the first queue does not include any data; and
in response, using the data placed into the second queue to train or update the ML model.

8. The method of claim 1, wherein only the data placed into the first queue is used to train or update the ML model.

9. A computing system comprising:
a processor;
a non-transitory storage medium having stored therein instructions that are executable by the processor that cause the computing system to perform operations comprising:
receiving data provided by a plurality of edge nodes that is to be used in training or updating a machine learning (ML) model;
identifying a confidence score associated with the data provided by the plurality of edge nodes;
placing the data provided by the plurality of edge nodes that is determined to have a high confidence score into a first queue;
placing the data provided by the plurality of edge nodes that is determined to have a low confidence score into a second queue; and
using the data placed into the first queue and/or the second queue to train or update the ML model.

10. The computing system of claim 9, wherein the plurality of edge nodes comprise respective nodes of a data confidence fabric (DCF).

11. The computing system of claim 9, wherein the confidence score concerns performance of hardware and/or software of each of the plurality of edge nodes.

12. The computing system of claim 9, wherein a confidence score is determined to be a high confidence score, or a low confidence score based on a configurable confidence score threshold.

13. The computing system of claim 9, further comprising:
using the data placed into the second queue to train or update the ML model only after the data in the first queue has been used to train or update the ML model.

14. The computing system of claim 9, further comprising:
after using the data in the first queue to train or update the ML model, determining if the ML model is sufficiently trained or updated; and
if the ML model is not sufficiently trained or updated, using the data placed into the second queue to train or update the ML model.

15. The computing system of claim 9, further comprising:
determining that the first queue does not include any data; and
in response, using the data placed into the second queue to train or update the ML model.

16. The computing system of claim 9, wherein only the data placed into the first queue is used to train or update the ML model.

17. A non-transitory storage medium having stored therein instructions that are executable by one or more hardware processors to perform operations comprising:
receiving data provided by a plurality of edge nodes that is to be used in training or updating a machine learning (ML) model;
identifying a confidence score associated with the data provided by the plurality of edge nodes;
placing the data provided by the plurality of edge nodes that is determined to have a high confidence score into a first queue;
placing the data provided by the plurality of edge nodes that is determined to have a low confidence score into a second queue; and
using the data placed into the first queue and/or the second queue to train or update the ML model.

18. The non-transitory storage medium of claim 17, further comprising:
using the data placed into the second queue to train or update the ML model only after the data in the first queue has been used to train or update the ML model.

19. The non-transitory storage medium of claim 17, further comprising:
after using the data in the first queue to train or update the ML model, determining if the ML model is sufficiently trained or updated; and
if the ML model is not sufficiently trained or updated, using the data placed into the second queue to train or update the ML model.

20. The non-transitory storage medium of claim 17, further comprising:
determining that the first queue does not include any data; and
in response, using the data placed into the second queue to train or update the ML model.
